(19) United States
(12) Patent Application Publication
(10) Pub. No.: US 2017/0160119 A1
(43) Pub. Date: Jun. 8, 2017

(54) FLUID DISPENSING MEASUREMENT AND REPORTING SYSTEM AND NETWORK

(71) Applicant: Nowell Outlaw, Lafayette, CO (US)

(72) Inventor: Nowell Outlaw, Lafayette, CO (US)

(21) Appl. No.: 15/373,195

(22) Filed: Dec. 8, 2016

Related U.S. Application Data
(60) Provisional application No. 62/264,759, filed on Dec. 8, 2015.

(51) Int. Cl. G01F 15/06; G06Q 10/00; G06Q 50/26; B67D 1/08; E03B 7/07

(52) U.S. Cl. CPC G01F 15/063; B67D 1/0855; B67D 1/0888; E03B 7/072; G06Q 50/26; G06Q 10/30; B67D 1/0014

(57) ABSTRACT

A flow material reporting system comprising a flow material measuring device and at least one a computing device communicatively coupled to the flow material measuring device, with the computing device comprising a flow material monitoring portion, a flow material measuring portion, and a flow material reporting portion.

### PRIORITY

This application claims priority to U.S. Provisional Application No. 62/264,759, entitled “Liquid Dispensing Measurement, Reporting System, and Network,” filed Dec. 8, 2015, and incorporated herein by reference in its entirety.

### FIELD OF THE INVENTION

This application relates to a liquid-dispensing measurement and reporting system. In particular, but not intended to limit the invention, the application relates to monitoring, measuring, and reporting the environmental impact related to water line drinking water usage across varying locations.

### BACKGROUND OF THE INVENTION

A company's main goal is nearly always to return a profit to the corporation's owners. However, a company may also undertake additional goals in that process. One such additional goal may be to provide a contribution to a charitable organization (run by the company or otherwise) or to engage in environmentally-sound practices. Such additional goals may further the company's main goal of returning a profit by providing beneficial and potentially free advertising to the company through the form of news articles or otherwise. This advertising may draw new customers to the company that wish to support such altruistic objectives. Furthermore, a company may realize that undertaking an environmentally-sound practice may also save the company costs.

### SUMMARY OF THE INVENTION

In order to provide companies with an environmentally-sound practice, a liquid-dispensing measurement and reporting system has been created. Such a system is adapted to determine the amount of fluid flowing through a fluid line and provide reports and displays related to this amount. One such liquid may comprise water, flowing through a water line, and connected to a water tap providing filtered water to refill personal water bottles.

One embodiment of the invention comprises a flow material reporting system. One flow material reporting system comprises a flow material measuring device and at least one computing device communicatively coupled to the flow material measuring device, the computing device comprising a flow material monitoring portion, a flow material measuring portion, and a flow material reporting portion.

Another embodiment of the invention comprises a flow material reporting network comprising a plurality of flow material reporting systems and a plurality of computing devices communicatively coupled to the plurality of flow material reporting systems. Each of the plurality of flow material reporting systems comprise a flow material measuring device and the plurality of computing devices comprises a first computing device comprising a flow material monitoring portion, a flow material measuring portion, and a flow material reporting portion and a second computing device.

Yet another embodiment of the invention comprises a method of analyzing an amount of fluid flow. One such method comprises detecting fluid flow in one or more locations, determining an amount of fluid flow associated with one or more locations, and associating the amount of fluid flow with a fluid type. The method further comprises calibrating a volume of fluid flow for the one or more locations and analyzing the fluid flow to provide one or more outputs related to at least one environmental impact.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 depicts a flow material reporting system according to one embodiment of the invention;

FIG. 2 depicts a display comprising environmental information according to one embodiment of the invention;

FIG. 3 depicts a display comprising environmental information according to one embodiment of the invention;

FIG. 4 depicts information related to at least a portion of a flow material reporting system according to one embodiment of the invention;

FIG. 5 depicts a flow material reporting network according to one embodiment of the invention;

FIG. 6 depicts a method according to one embodiment of the invention; and

FIG. 7 depicts a diagrammatic representation of one embodiment of a computer system according to one embodiment of the invention.

### DETAILED DESCRIPTION

Reference throughout this specification to “one embodiment,” “an embodiment,” and other similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided for a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

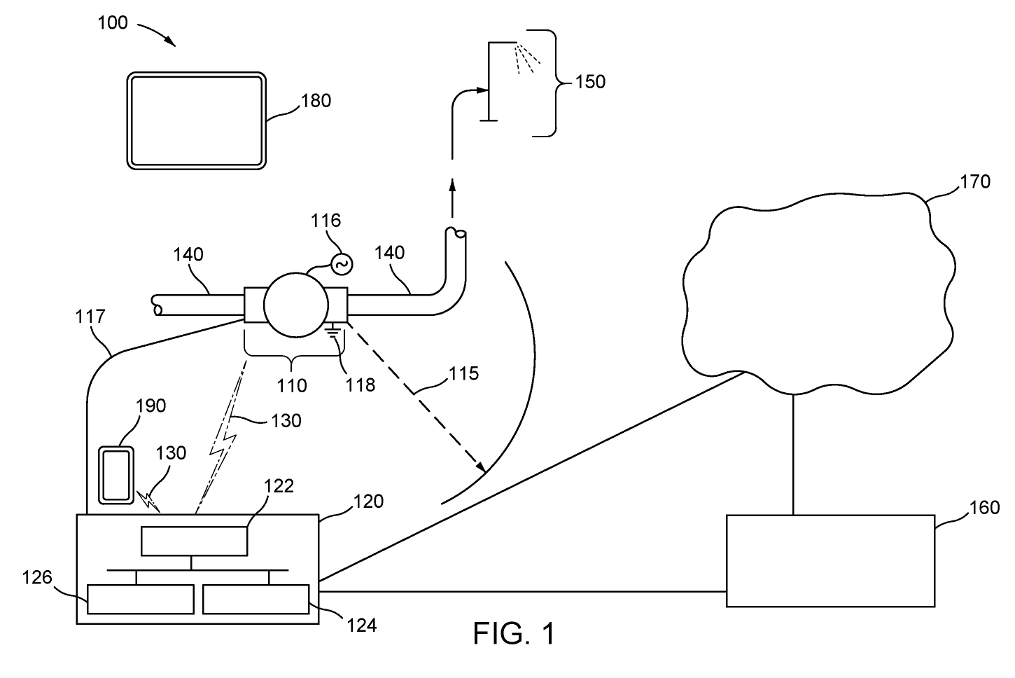

Turning first to FIG. 1, seen is a flow material reporting system 100 comprising a flow material measuring device 110 and a computing device 120 communicatively coupled to the flow material measuring device 110. The flow material measuring device 110 may comprise an inline flow sensor adapted to measure the flow rate of a fluid flowing through the flow material measuring device 110. The computing device 120 seen in FIG. 1 comprises a diagrammic representation of a computing device 120 and comprises a flow material monitoring portion 122, a flow material measuring portion 124, and a flow material reporting portion 126. Each of the flow material monitoring portion 122, flow material measuring portion 124, and flow material reporting portion 126 may comprise a non-transitory, tangible computer-readable storage medium, encoded with processor readable functions to perform a method. For example, the flow material monitoring portion 122 (or the flow material measuring portion 124 or flow material reporting portion 126) may comprise a method to communicate wirelessly 130 with the flow material measuring device 110. Wired connections and communications with the flow material measuring device are also contemplated and are described herein. With either communication, data sent and/or received may be related to the flow of material through the flow material measuring device 110. One such device 110 may be coupled to a water line 140 coupled to a water dispensing unit 150. One water dispensing unit 150 may comprise a drinking water machine. One drinking water machine may comprise a water dispenser or a water fountain. The data may comprise the amount of water flowing to the water machine. The flow material measuring portion 124 may comprise a method to measure and record such an amount of water while the flow material reporting portion 126 may comprise a method for analyzing and providing one or more reports based on such data, as described herein.

The computing device 120 may comprise a plurality of computing devices. For example, one or more computing devices 120 may be coupled to one or more flow material measuring devices 110. It is contemplated that the computing devices 120 coupled to the flow material measuring devices 110 may be located within a wireless transmission range 115 of the flow material measuring devices 110. However, the computing device 120 may be coupled to the flow material measuring device 110 through a wired connection as well (e.g., the wired data line 117). It is further contemplated that the computing device 120 may comprise one or more first computing devices and the one or more first computing devices may comprise gateways communicatively coupled to one or more second computing devices 160. The second computing devices 160 and/or the first computing devices may be communicatively coupled to a network such as, but not limited to, the internet or cloud 170. Furthermore, the second computing devices 160 may comprise one or more portions of the flow material monitoring portion 122, flow material measuring portion 124, and flow material reporting portion 126.

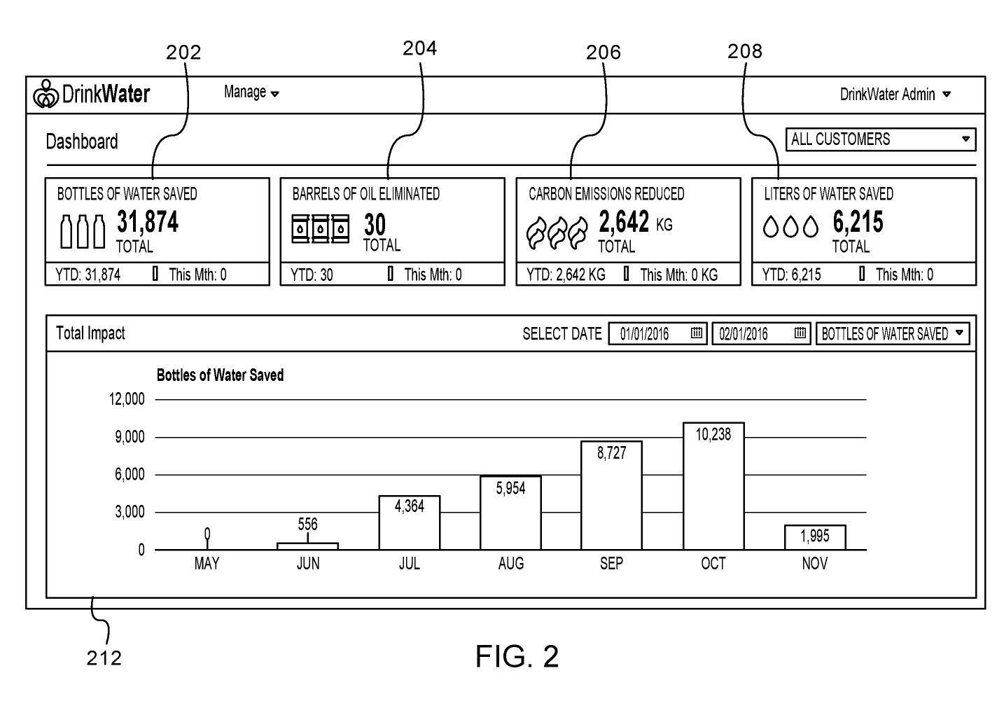

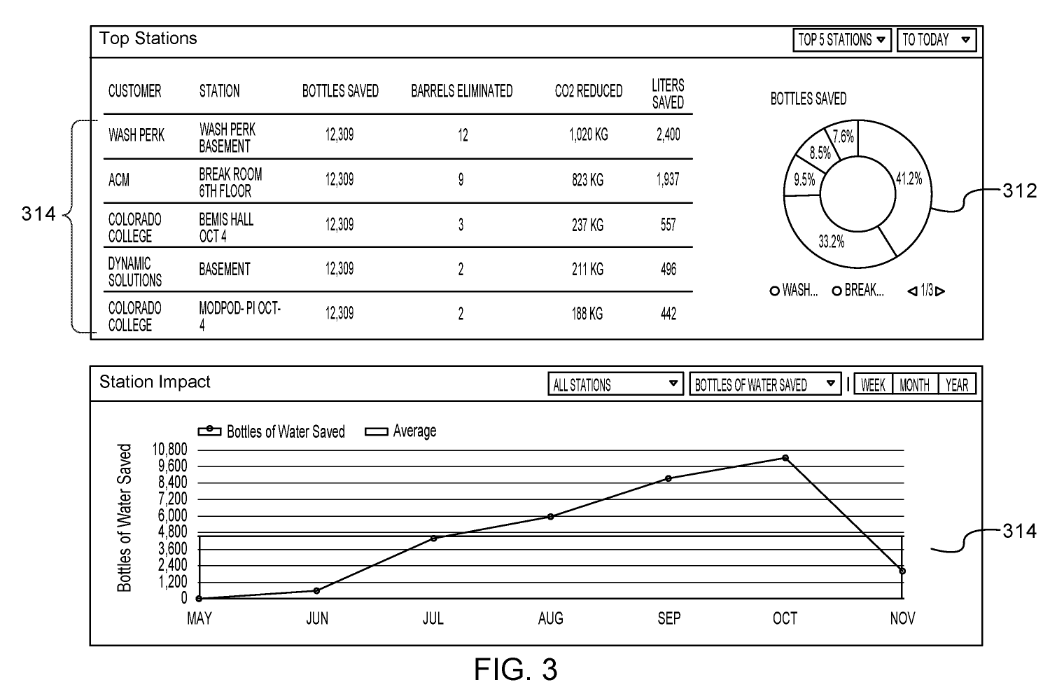

The flow material monitoring portion 122, flow material measuring portion 124, and flow material reporting portion 126 may receive and/or provide various environmental impact information, for example, the information described herein related to FIG. 2. In one embodiment, a determination may be made regarding the environmental impact information and a display may be provided with respect to a number of water bottles saved 202, barrels of oil eliminated 204, carbon emissions reduced 206 and/or liters of water saved 208. Similarly, the flow material monitoring portion 122, flow material measuring portion 124, and flow material reporting portion 126 may provide and display similar information related to graphs 212, 312 and tables 314, as also seen in FIG. 3. Additional information is also contemplated. Environmental information may comprise information related to a specific geographic location of one or more flow material measuring devices 110 or information related to a specified timeframe or for a particular entity. For example, a single entity may comprise a business having hundreds or thousands of flow material measuring devices 110 and a graph 312 and/or table 314 may be created displaying information related to one or more of these locations.

As seen in FIG. 1, the flow material reporting system 100 may comprise a screen 180. The screen 180 may be communicatively coupled to the measuring device 110 and/or computing devices 120, 160, through the cloud 170 or otherwise, to receive and display the graphs 312, tables 314 and other information related to the data received from the flow material measuring device 110. Although the environmental impact information displayed on the screen 180 may comprise information related to the amount of at least one of plastic water bottles, barrels of oil, carbon dioxide, and water saved, it is contemplated that the information displayed may comprise other environmental impact information and other information in general. The other information displayed on the screen 180 may comprise information related to the water in the water line 140. For example, additional sensors and/or probes may be included in the measuring device 110 to provide operational support information related to water quality, water volume flow, water of compressor temperature, and/or condition of one or more portions of the equipment in the system 100, e.g., status of a water filter (fresh/needs replacement). Such information may be provided across a network of stations for a single entity or multiple entities. In one embodiment, the data displayed on the screen 180 may be first sent to an internal reporting system and an API may be used to pull the data. Furthermore, the data may be embedded into a third-party application such as, but not limited to, Facebook™ or Twitter™.

It is contemplated that at least a portion of the flow material monitoring portion 122, flow material measuring portion 124, and/or flow material reporting portion 126 may comprise hardware and/or firmware. For example, the flow material measuring device 110 may be electronically and/or communicatively coupled printed circuit board (PCB). One PCB may comprise a sensor board with a wireless communication device. For example, one such wireless transmission device may communicate in the ISM radio band such as 915 or 868 MHz. The 915 MHz RF may be the designated ISM transmission frequency for the United States. In any event, the communication between at least a portion of the plurality of computing devices 120, 160 and the plurality of flow material measuring devices 100 may comprise a wireless communication having a frequency of less than 1 GHz. For example, communication between a board and a gateway may utilize a frequency of less than 1 GHz. Other wireless communications may use a different frequency.

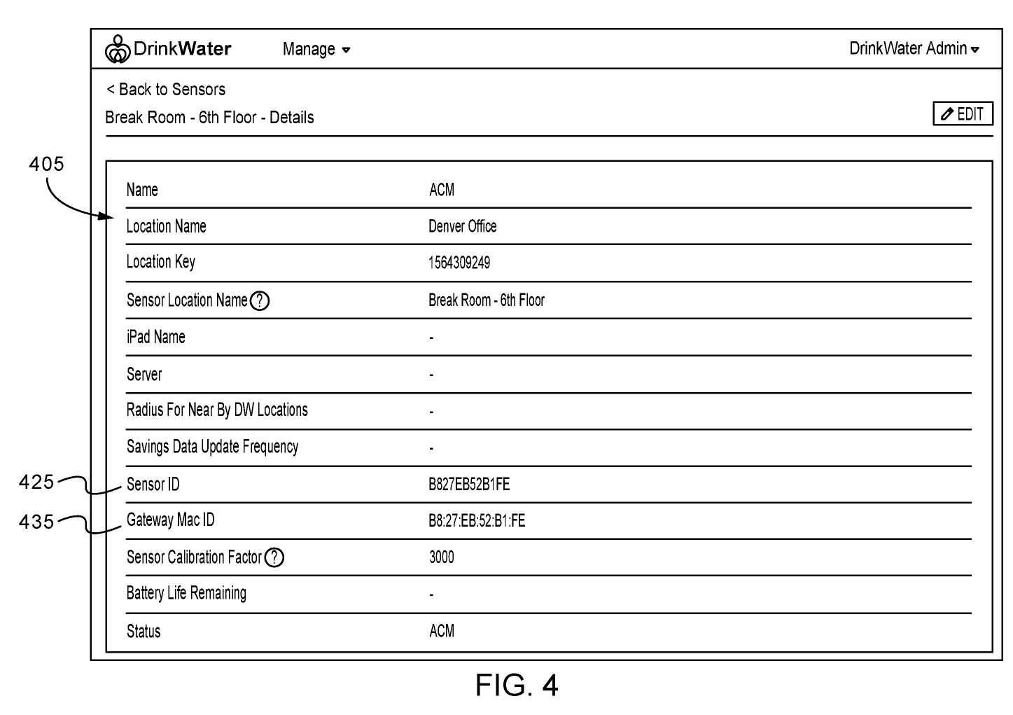

In one embodiment, the computing device 120 may comprise a board comprising a Raspberry Pi™ board provided by the Raspberry Pi Foundation located in Cambridge, United Kingdom. Other boards such as, but not limited to, Arduino boards, are also contemplated. With such a board, data received at the board from the device 100 may be wirelessly transmitted to another computing device 120. The computing device 120 may comprise a gateway computer in other embodiments not comprising such a board. These gateway devices may utilize a 915/868 Mhz wireless connection. Alternatively, instead of using a coping device 120 comprising a sensor board such as, but not limited to the Raspberry Pi™ board communicating with computing device 120 comprising a gateway, the flow material measuring device 110 may be coupled to an internet of things sensor board that connects natively to Wi-Fi or connected via Cellular/GSM. o gateway device may be needed with such a board. It is contemplated that configuration of either sensor board may be conducted via a mobile computing device 190 such as, but not limited to, an iPhone, android, tablet, or any other device that has the ability to connect to the board's wireless communication device, for example, via TCP/IP. For example, such a wireless computing device 190 may comprise the ability to configure, identify and/or associated various information with the flow material measuring device 110 and board coupled to the device 110. Seen in FIG. 4 is one interface 405 that may be utilized for such configuration. Such an interface 405 may enable tracking of a sensor ID 425, MAC address 435, and provide access to additional information, as seen in FIG. 4. By coupling the flow material measuring device 110 and the sensor embedded therein, to a board, the system 100 is able to capture the data/determine the volume of water transmitted through the line 140 and this information may be accessible to the cloud 170.

The board coupled to the flow material measuring device 110 may comprise a CC3200 onboard Wi-Fi chip from Texas Instruments, located at 12500 TI Boulevard in Dallas, Tex. 75243. Such a chip may enable the device to provide flow data via Wi-Fi; however, other chips and/or other hardware/firmware/software configurations may provide a similar capability. For example, one board or other portion of the system may enable cellular network communications. In one such embodiment, the board may communication via GSM network communications. The board may further comprise a CC2640 Bluetooth Low Energy chip that may enable the board to act as a beacon using the Apple Corporation i-beacon framework or Google, Inc. Eddystone framework. Other hardware/firmware/software configurations may provide a similar capability. In a board-configured system 100, the flow material measuring device 110 may couple to a power supply 116, ground 118 and wired data line 117 (pulse data rate) to the board (i.e., computing device 120). In one embodiment, upon receiving the data from the inline flow sensor in the flow material measuring device 110 through the data line 117, the flow material measuring portion 122 may determine an amount of water passing through the inline flow sensor. The board may then calculate the water flow and provide the water flow data to the cloud 170.

It is contemplated that the flow material measuring device 110 and computer 120 (e.g., when the computer 120 comprises a Wi-Fi-enabled board, as described above) may comprise at least one of a network-connected sensor (e.g., the inline flow sensor) and a single-board computer. Each of the network-connected sensor and a single-board computer may also comprise a wireless data transmission device, with the wireless data transmission device comprising a data transmission range 115 and the single board computer and/or second computer 160 or additional first computer 120 being located within the data transmission range 115. One such range 115 may comprise a cellular access range.

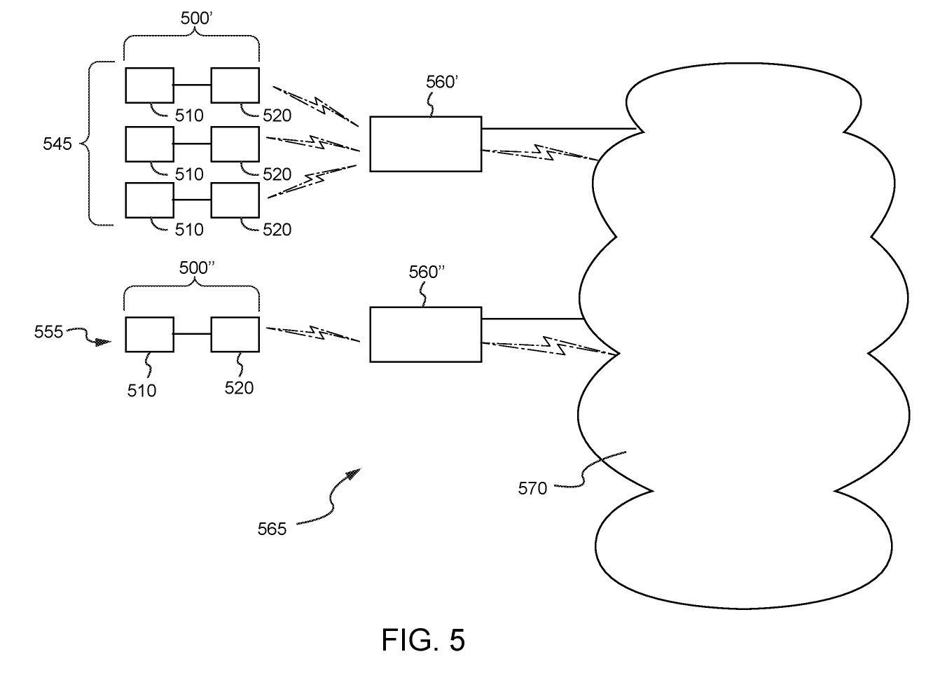

It is further contemplated that one embodiment of the invention comprises a flow material reporting network comprising a plurality of the flow material reporting systems 100 seen in FIG. 1. For example, seen in FIG. 5 is network 565 comprising a first entity 545 having a plurality of first flow material reporting systems 500′ and a second entity 555 having at least one flow material reporting system 500″. The first entity 545 and second entity 555 may comprise different entities (i.e., separate and distinct businesses). It is contemplated that the flow material reporting systems 500′, 500″ may at least comprise a flow material measuring device 510 and a computing device 520 communicatively coupled to the flow material measuring device 510, with the computing device 520 comprising a board (PCB) computing device, as described above. Alternatively or additionally, the computing device 520 may comprise a gateway device. In either scenario, the computing device 520 may communicate with one or more second computing devices 560′, 560″. It is contemplated that the second computing devices 560′, 560″ may comprise servers in the cloud 570.

One first entity's 545 flow material reporting systems 500′ may communicate with one or more initial second computing devices 560′ while the second entity's 555 flow material reporting systems 500″ may communicate with one or more other second computing devices 560″ different than the initial second computing devices 560′. However, the flow material reporting systems 500′, 500″ may also communicate with the same second computing devices 560. It is contemplated that the second computing devices may be owned and/or operated by a third entity different from the first and second entity. The third entity may also install the reporting systems 500 into locations owned and operated by the first and second entity, and may provide the various reports, graphs 212, 312 and tables 314 described herein and known in the art.

It is contemplated that at least a portion of the flow material monitoring portion 122, flow material measuring portion 124, and/or flow material reporting portion 126 may comprise a non-transitory, tangible computer-readable storage medium, encoded with processor readable function to perform a method of device communication. For example, one such method may comprise receiving and/or sending a communication at to and/or from at least one of the first computing device 120 and second computing device 160. The method may further comprise implementing an application programming interface to receive data from at least a portion of the flow material reporting system 100 and using data sent from one or more inline flow sensors to determine an amount of fluid flowing through the device 110 and provide information related to the amount of fluid. For example, and as previously discussed, the information provided may be related to environmental impact information. The one or more first computing devices and one or more second computing devices may comprise an additional hardware component communicatively coupled to the application programming interface and used to receive data from the inline flow sensor/flow material reporting device 110.

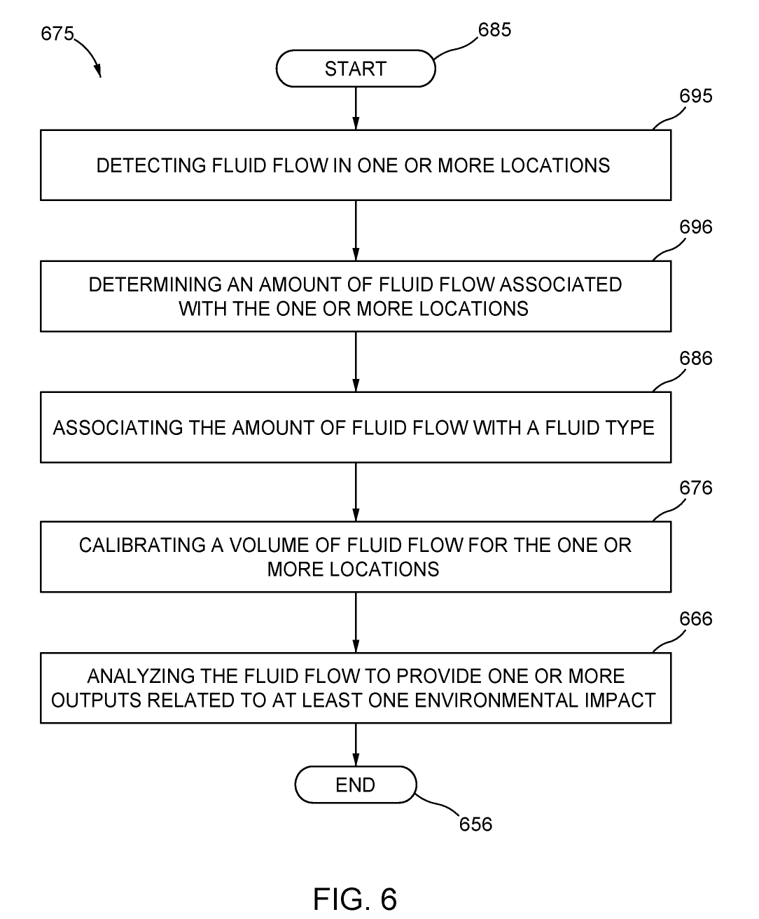

Turning now to FIG. 6, seen is a method 675 of analyzing an amount of fluid flow. One method 675 starts at 685 and at 695 comprises detecting fluid flow in one or more locations. For example, fluid flow may be detected using the system 100 described with reference to FIGS. 1 and 5 and elsewhere throughout the application. At step 696, the method 675 comprises determining an amount of fluid flow associated with one or more locations. At step 686 the method 675 comprises associating the amount of fluid flow with a fluid type, while at 676, the method comprises calibrating a volume of fluid flow for the one or more locations. At 666, the method 675 comprises analyzing the fluid flow to provide one or more outputs related to at least one environmental impact. The method 675 ends at 656.

In one embodiment, detecting fluid flow in one or more locations 695 may comprise coupling an in-line flow sensing device (e.g., device 110) to a water line 140 and using the in-line digital flow sensing device at each of the one or more locations to determine when flow has initiated in the water line 140 at each of the one or more locations. Although not shown in FIG. 6, the method 675 may further transfer data from the in-line digital flow sensing device to one or more computing devices 120, 160.

Furthermore, analyzing the fluid flow to provide one or more outputs related to at least one environmental impact 666 or operational impact may comprise utilizing the one or more computing devices 120, 160 to provide an impact on a geographical area related to the aggregate amount of water emitted from the in-line digital flow sensing devices. Such a “geographical impact” may comprise displaying for a geographical area at least one of, a total number of plastic water bottles prevented from use by providing drinkable water through the water line 140 (e.g., through a drinking water machine utilizing the system 100), a number of barrels of oil prevented from consumption by providing water line 140 drinkable water, and/ or an amount of carbon dioxide emissions reduced through the use of drinkable water from the water line 140. Other impacts are contemplated.

One such geographical impact comprises an environmental impact score relating to an algorithmic calculation. Such environmental impact scores may be compared amongst companies or entity types within or outside of a geographical area. In one embodiment, the environmental impact score may comprise a value related to at least one of a first entity and first location. For example, the value may comprise the value for a particular water line 140 or drinking water machine or building comprising multiple drinking water machines. Or, the score may be related to the companies use of water lines to provide drinking water machines across multiple buildings in a particular city or across multiple cities for an entire company. Multiple scores may be created for multiple companies/entities/locations.

One environmental impact score comprises a value related to a volume of fluid dispensed from the in-line flow-sensing device, a size of an entity associated with the in-line flow-sensing device, a location of the flow-sensing device, an amount of first goods provided by the entity, wherein the first goods comprise a first specified goods type, an amount of second goods provided by the entity, wherein the second goods comprise a second specified goods type, the second specified goods type being different than the first specified goods type, a frequency of fluid testing at the location; and an amount of recycling conducted by the entity.

The environmental score may take into account that, for example, a small fifty-room hotel cannot compete with a worldwide hotel chain comprising more than four thousand hotels by incorporating a business's size into an environmental impact metric. For example, one or more of the following factors may be implemented in determining the score: Factor 1: Liquid volume dispensed from the system 100 in the network 565 analyzed. Factor 2: Business size, putting the volume of liquid in Factor 1 on a level playing field across all businesses. Factor 3: Location of each system 100. Similar to Factor 2, location may be taken into account in order to provide an apples-to-apples comparison of liquid dispensed across local, regional, and world-wide businesses. This factor, together with factor 2, allows a small business in one location, for example, Boulder, Colo. to be compared with another small business in Boulder, Colo. instead of a large corporation based in New York, N.Y. Factor 4: Plastic Water Bottles Sold—whether the business sells plastic water bottles, and potentially an estimated number of bottles sold, impacts their score. Factor 5: whether reusable bottles/containers are available for sale at the business, and potentially an estimated number sold, may be taken into account. Factor 6: Whether reusable bottles/containers are available for loan to customers, and the numbers available for loan/are loaned over a period of time. Factor 7 is the frequency of water testing done at, or by, the company. For example, a frequency option of 6 months, 9 months, or 12 months may be selected. Factor 8 is whether drinkable water is sold or free to the company's customers. Factor 9 is whether glass water bottles are provided and/or refilled for customers (in their hotel room for hotels, for example). Factor 10: Does the company use or implement any recycling programs? If so, this factor may further take into account the kind and number of recycling programs, as well as the level of implementation in the company.

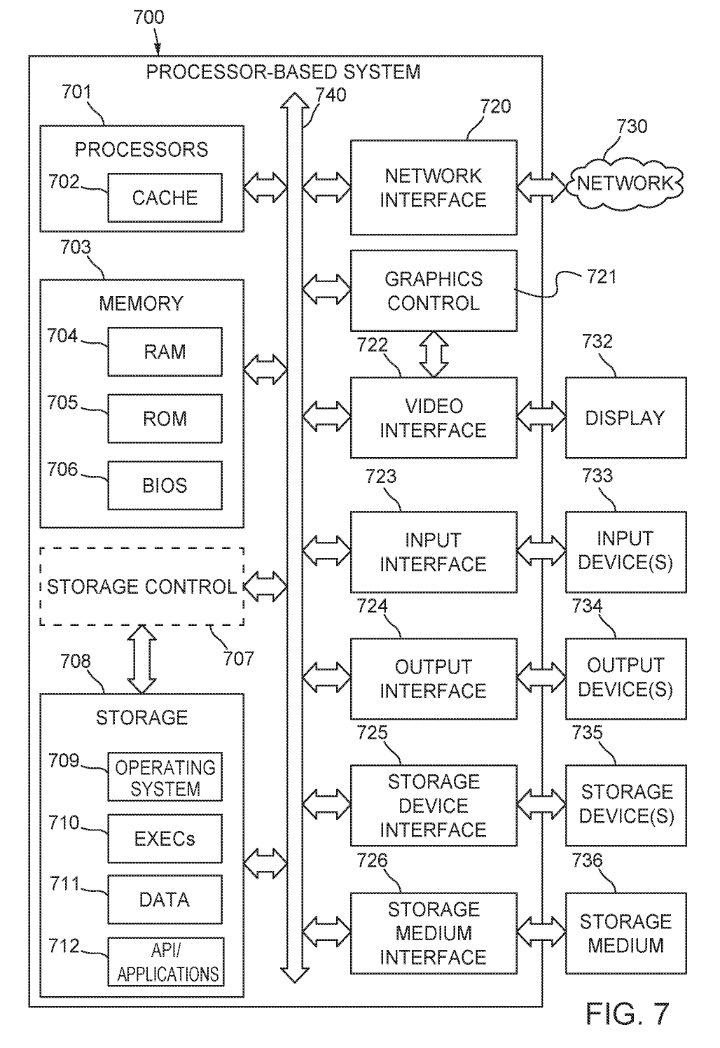

The systems and methods described herein can be implemented in a computer system in addition to the specific physical devices described herein. FIG. 7 shows a diagrammatic representation of one embodiment of a computer system 700 within which a set of instructions can execute for causing a device to perform or execute any one or more of the aspects and/or methodologies of the present disclosure. The components in FIG. 7 are examples only and do not limit the scope of use or functionality of any hardware, software, firmware, embedded logic component, or a combination of two or more such components implementing particular embodiments of this disclosure. Some or all of the illustrated components can be part of the computer system 700. For instance, the computer system 700 can be a general purpose computer (e.g., a laptop computer) or an embedded logic device (e.g., an FPGA), to name just two non-limiting examples.

Computer system 700 includes at least a processor 301 such as a central processing unit (CPU) or an FPGA to name two non-limiting examples. Any of the subsystems described throughout this disclosure could embody the processor 701. The computer system 700 may also comprise a memory 703 and a storage 708, both communicating with each other, and with other components, via a bus 740. The bus 740 may also link a display 732, one or more input devices 733 (which may, for example, include a keypad, a keyboard, a mouse, a stylus, etc.), one or more output devices 734, one or more storage devices 735, and various non-transitory, tangible computer-readable storage media 736 with each other and/or with one or more of the processor 701, the memory 703, and the storage 708. All of these elements may interface directly or via one or more interfaces or adaptors to the bus 740. For instance, the various non-transitory, tangible computer-readable storage media 736 can interface with the bus 740 via storage medium interface 726. Computer system 700 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 701 (or central processing unit(s) (CPU(s))) optionally contains a cache memory unit 732 for temporary local storage of instructions, data, or computer addresses. Processor(s) 701 are configured to assist in execution of computer-readable instructions stored on at least one non-transitory, tangible computer-readable storage medium. Computer system 700 may provide functionality as a result of the processor(s) 701 executing software embodied in one or more non-transitory, tangible computer-readable storage media, such as memory 703, storage 708, storage devices 735, and/or storage medium 736 (e.g., read only memory (ROM)). Memory 703 may read the software from one or more other non-transitory, tangible computer-readable storage media (such as mass storage device(s) 735, 736) or from one or more other sources through a suitable interface, such as network interface 720. Any of the subsystems herein disclosed could include a network interface such as the network interface 720. The software may cause processor(s) 701 to carry out one or more processes or one or more steps of one or more processes described or illustrated herein. Carrying out such processes or steps may include defining data structures stored in memory 703 and modifying the data structures as directed by the software. In some embodiments, an FPGA can store instructions for carrying out functionality as described in this disclosure. In other embodiments, firmware includes instructions for carrying out functionality as described in this disclosure.

The memory 703 may include various components (e.g., non-transitory, tangible computer-readable storage media) including, but not limited to, a random access memory component (e.g., RAM 704) (e.g., a static RAM “SRAM”, a dynamic RAM “DRAM, etc.), a read-only component (e.g., ROM 705), and any combinations thereof. ROM 705 may act to communicate data and instructions unidirectionally to processor(s) 701, and RAM 704 may act to communicate data and instructions bidirectionally with processor(s) 701. ROM 705 and RAM 704 may include any suitable non-transitory, tangible computer-readable storage media. In some instances, ROM 705 and RAM 704 include non-transitory, tangible computer-readable storage media for carrying out a method. In one example, a basic input/output system 706 (BIOS), including basic routines that help to transfer information between elements within computer system 700, such as during start-up, may be stored in the memory 703.

Fixed storage 708 is connected bi-directionally to processor(s) 701, optionally through storage control unit 707. Fixed storage 708 provides additional data storage capacity and may also include any suitable non-transitory, tangible computer-readable media described herein. Storage 708 may be used to store operating system 709, EXECs 710 (executables), data 711, API applications 712 (application programs), and the like. Often, although not always, storage 708 is a secondary storage medium (such as a hard disk) that is slower than primary storage (e.g., memory 703). Storage 708 can also include an optical disk drive, a solid-state memory device (e.g., flash-based systems), or a combination of any of the above. Information in storage 708 may, in appropriate cases, be incorporated as virtual memory in memory 703.

In one example, storage device(s) 735 may be removably interfaced with computer system 700 (e.g., via an external port connector (not shown)) via a storage device interface 725. Particularly, storage device(s) 735 and an associated machine-readable medium may provide nonvolatile and/or volatile storage of machine-readable instructions, data structures, program modules, and/or other data for the computer system 300. In one example, software may reside, completely or partially, within a machine-readable medium on storage device(s) 735. In another example, software may reside, completely or partially, within processor(s) 701.

Bus 740 connects a wide variety of subsystems. Herein, reference to a bus may encompass one or more digital signal lines serving a common function, where appropriate. Bus 740 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 700 may also include an input device 733. In one example, a user of computer system 700 may enter commands and/or other information into computer system 700 via input device(s) 733. Examples of an input device(s) 733 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 733 may be interfaced to bus 740 via any of a variety of input interfaces 723 (e.g., input interface 723) including, but not limited to, serial, parallel, game port, USB, FIREWIRE, THUNDERBOLT, or any combination of the above.

In particular embodiments, when computer system 700 is connected to network 730, computer system 700 may communicate with other devices, such as mobile devices and enterprise systems, connected to network 730. Communications to and from computer system 700 may be sent through network interface 720. For example, network interface 720 may receive incoming communications (such as requests or responses from other devices) in the form of one or more packets (such as Internet Protocol (IP) packets) from network 730, and computer system 700 may store the incoming communications in memory 703 for processing. Computer system 700 may similarly store outgoing communications (such as requests or responses to other devices) in the form of one or more packets in memory 703 and communicated to network 730 from network interface 720. Processor(s) 701 may access these communication packets stored in memory 703 for processing.

Examples of the network interface 720 include, but are not limited to, a network interface card, a modem, and any combination thereof. Examples of a network 730 or network segment 730 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 730, may employ a wired and/or a wireless mode of communication. In general, any network topology may be used.

Information and data can be displayed through a display 732. Examples of a display 732 include, but are not limited to, a liquid crystal display (LCD), an organic liquid crystal display (OLED), a cathode ray tube (CRT), a plasma display, and any combinations thereof. The display 732 can interface to the processor(s) 701, memory 703, and fixed storage 708, as well as other devices, such as input device(s) 733, via the bus 740. The display 732 is linked to the bus 740 via a video interface 722, and transport of data between the display 732 and the bus 740 can be controlled via the graphics control 721.

In addition to a display 732, computer system 700 may include one or more other peripheral output devices 734 including, but not limited to, an audio speaker, a printer, and any combinations thereof. Such peripheral output devices may be connected to the bus 740 via an output interface 724. Examples of an output interface 724 include, but are not limited to, a serial port, a parallel connection, a USB port, a FIREWIRE port, a THUNDERBOLT port, and any combinations thereof.

In addition or as an alternative, computer system 700 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein (e.g., the method 675) may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 700 shown in FIG. 7 such as, but not limited to, the network 730, processor 701, memory, 703, etc., may comprise a cloud computing system. In one such system, front-end systems such as input devices 733 may provide information to back-end platforms such as servers (e.g. computer systems 700) and storage (e.g., memory 703). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A flow material reporting system comprising,
a flow material measuring device;
a computing device communicatively coupled to the flow material measuring device, the computing device comprising,
a flow material monitoring portion,
a flow material measuring portion, and
a flow material reporting portion.

2. The flow material reporting system of claim 1 wherein,
the flow material comprises water; and
at least one of the flow material measuring portion and the flow material reporting portion relates to one of an environmental impact and operational information.

3. The flow material reporting system of claim 2 further comprising an electronic display and wherein,
the electronic display provides a graphic related to the environmental impact; and
the environmental impact comprises a reduction amount of at least one of:
plastic water bottles,
barrels of oil,
carbon dioxide, and
water saved.

4. The flow material reporting system of claim 2 wherein,
the flow material measuring device comprises an inline flow sensor; and
the flow material measuring portion determines an amount of water passing through the inline flow sensor.

5. The flow material reporting system of claim 1, wherein,
the flow material measuring device comprises at least one of a network-connected sensor communicatively coupled to a single-board computer;
the single-board computer comprises a data transmission device.
the wireless data transmission device comprising a data transmission range; and
the computing device is located with the data transmission range.

6. A flow material reporting network comprising,
a plurality of flow material reporting systems, wherein each of the plurality of flow material reporting systems comprise a flow material measuring device; and
a plurality of computing devices communicatively coupled to one or more of the plurality of flow material measuring devices, the plurality of computing devices comprising,
a flow material monitoring portion,
a flow material measuring portion, and
a flow material reporting portion.

7. The network of claim 6 wherein, the plurality of computing devices comprises,
one or more first computing devices comprising gateway devices; and
one or more second computing devices comprising cloud-based servers.

8. The network of claim 7 wherein,
the plurality of flow material reporting systems comprise systems are at least one of owned and operated by a first entity; and
the one or more first computing devices and one or more second computing devices comprise devices are at least one of owned and operated by a second entity.

9. The network of claim 8 wherein, communication between at least a portion of the plurality of computing devices and the plurality of flow material reporting systems comprises one of a wireless communication having a frequency of less than 1 GHz, cellular/GSM data, and Wi-Fi data.

10. The network of claim 8 further comprising a non-transitory, tangible computer-readable storage medium, encoded with processor readable functions to perform a method of device communication comprising,
receiving a communication at one of the first computing device and second computing device from the flow material reporting system;
implementing an application programming interface to receive data from the flow material reporting system; and
using the data to,
determine an amount of fluid identified by the plurality of flow material reporting systems, and
provide information related to the amount of fluid.

11. The network of claim 10 wherein, the information related to the amount of fluid comprises at least one of environmental impact and operational information.

12. The network of claim 10 wherein the one or more first computing devices and one or more second computing devices comprise an additional hardware component communicatively connected to the application programming interface and used to receive data from the flow material reporting system.

13. A method of analyzing an amount of fluid flow comprising,
detecting fluid flow in one or more locations;
determining an amount of fluid flow associated with one or more locations;
associating the amount of fluid flow with a fluid type;
calibrating a volume of fluid flow for the one or more locations; and
analyzing the fluid flow to provide one or more outputs related to at least one environmental impacts.

14. The method of claim 13 wherein, detecting fluid flow in one or more locations comprises,
coupling an in-line flow sensing device to a water line;
using the in-line digital flow sensing device at each of the one or more locations to determine when flow has initiated at each of the one or more locations.

15. The method of claim 14 further comprising, transferring data from the in-line digital flow sensing device to one or more computing devices.

16. The method of claim 15 wherein,
the fluid type comprises water;
analyzing the fluid flow to provide one or more outputs related to at least one environmental impacts comprises utilizing the one or more computing devices to provide a geographical impact related to the aggregate amount of water emitted from the in-line digital flow sensing device.

17. The method of claim 16 wherein, the geographical impact comprises displaying for a geographical area at least one of,
a total number of plastic water bottles prevented from use through the utilization of the in-line flow-sensing device;
a number of barrels of oil prevented from consumption through the use of the in-line flow-sensing device;
an amount of carbon dioxide emissions reduced through the use of the in-line flow-sensing device; and
an amount of water reduced through the use of the in-line flow-sensing device.

18. The method of claim 16 wherein, the geographical impact comprises an environmental impact score relating to an algorithmic calculation and further comprising, comparing the environmental impact score with one or more other environmental impact scores.

19. The method of claim 18 wherein,
the environmental impact score comprises a value related to at least one of a first entity and first location;
the one or more other environmental impact scores comprises a value related to at least one of a second entity and second location;
the first entity is different than the second entity; and
the first location is different than the second location.

20. The method of claim 18 wherein, the environmental impact score comprise a value related to at least a plurality of,
a volume of fluid dispensed from the in-line flow-sensing device;
a size of an entity associated with the in-line flow-sensing device;
a location of the flow-sensing device;
an amount of first goods provided by the entity, wherein the first goods comprise a first specified goods type;
an amount of second goods provided by the entity, wherein the second goods comprise a second specified goods type, the second specified goods type being different than the first specified goods type;
a frequency of fluid testing at the location; and
an amount of recycling conducted by the entity.
